(19) United States
(12) Patent Application Publication
(10) Pub. No.: US 2004/0184610 A1
(43) Pub. Date: Sep. 23, 2004

(54) Chromatic dispersion encryption

(76) Inventor: Scott P. Campbell, Thousand Oaks, CA (US)

Correspondence Address: Scot A. Reader, Esq., Suite 420, 15300 Ventura Boulevard, Sherman Oaks, CA, 91403, US

(21) Appl. No.: 10/800,961

(22) Filed: Mar. 15, 2004

Related U.S. Application Data
(60) Provisional application No. 60/455,673, filed on Mar. 18, 2003.

(51) Int. Cl. G11B 27/36

(52) U.S. Cl. 380/54

(57) ABSTRACT

A method and system for using chromatic dispersion (CD) to encrypt and decrypt data transmitted between a source and a destination domain over an insecure transmission system. In one aspect, a chromatic dispersion encrypter (CDE) in a source domain induces upon data a first CD, thereby encrypting it, prior to transmitting the data on the insecure transmission system. A second optical device, herein called a chromatic dispersion decrypter (CDD), in a destination domain receives the data off the transmission system and induces upon the data a second CD, which is substantially the negative of the first CD, thereby decrypting it. The first and second optical devices may include etalon-based optical assemblies. In another aspect, the ripple amplitude and the ripple period of the CD profile configured on the first optical device is selected based on the data rate of the transmission system, thereby strengthening the encryption.

### CROSS-REFERENCE OF RELATED APPLICATION(S)

This application claims the benefit of U.S. provisional application 60/455,673, filed on Mar. 18, 2003, the contents of which are incorporated herein by reference.

### BACKGROUND OF INVENTION

Ubiquitous data exchange over insecure transmission systems has created a need to encrypt data to ensure its privacy. The predominant encryption methods in use today encipher and decipher data in electronic form through bit manipulation. In particular, a source domain sending a data message to a destination domain over an insecure transmission system uses an encryption key as part of a mathematical operation to modify bits of the message prior to transmitting it on the transmission system. The resulting “cipher text” is unreadable to any “snoopers” who might be present on the transmission system. The destination domain uses either the same encryption key (in symmetric, or private-key encryption) or a different encryption key (in asymmetric, or public-key encryption) to restore the data message to its original “clear text” form, rendering it readable in the destination domain.

A significant problem with the predominant encryption methods of today is their complexity and required overhead. Encryption keys must be securely distributed and maintained in both the source and destination domain. Encryption software must also be installed in the domains to enable them to properly utilize the encryption keys in enciphering and deciphering messages. And valuable processing resources are expended enciphering and deciphering each and every message.

### SUMMARY OF THE INVENTION

The invention, in a basic feature, provides a method and system for using chromatic dispersion (CD) to encrypt and decrypt data transmitted between a source and a destination domain over an insecure transmission system.

In one aspect, a chromatic dispersion encrypter (CDE) in a source domain induces upon data a first CD, thereby encrypting it, prior to transmitting the data on the insecure transmission system. A chromatic dispersion decrypter (CDD) in a destination domain receives the data off the transmission system and induces upon the data a second CD, which is substantially the negative of the first CD, thereby decrypting it. The CDE and the CDD may be etalon-based. The insecure transmission system may include an arbitrary number of intermediary optical devices, such as optical amplifiers and chromatic dispersion compensators (CDCs), coupled by optical transmission links.

In another aspect, the ripple amplitude and the ripple period of the CD profile configured on the first optical device is selected based on the data rate of the transmission system, thereby strengthening the encryption.

These and other aspects of the invention will be better understood by reference to the following detailed description, taken in conjunction with the accompanying drawings that are briefly described below. Of course, the actual scope of the invention is defined by the appended claims.

### BRIEF DESCRIPTION OF THE DRAWINGS

FIG. 1 shows a CD encryption-capable source domain and a CD decryption-capable destination domain communicatively coupled over a transmission system;

FIG. 2 shows a Gires-Toumois etalon (GTE) for use in CD-encrypting and CD-decrypting data transmitted between the source domain and destination domain of FIG. 1;

FIG. 3A shows an exemplary CD profile configured on a CDE for CD-encrypting data within the source domain of FIG. 1;

FIG. 3B shows an exemplary CD profile configured on a CDD for CD-decrypting data within the destination domain of FIG. 1; and

FIG. 4 shows the combinations of normalized group ripple amplitude (NGRA) and normalized group ripple period (NGRP) which achieve a 1 dB power penalty for a non-return to zero (NRZ) modulation format.

### DETAILED DESCRIPTION OF A PREFERRED EMBODIMENT

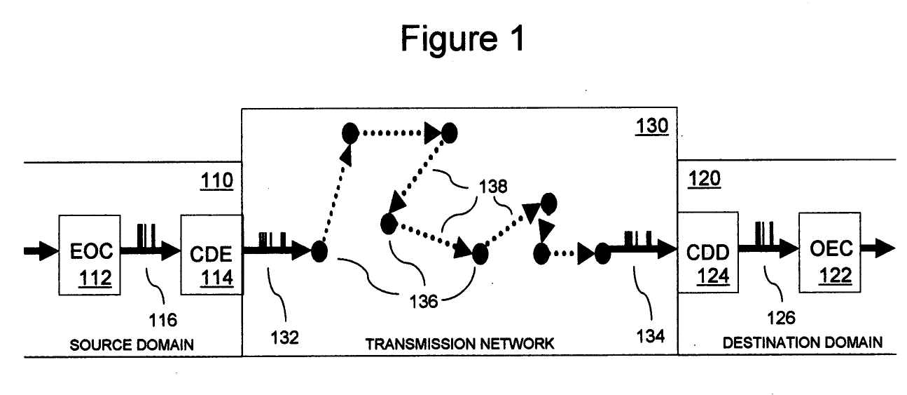

In FIG. 1, a CD encryption-capable source domain 110 and a CD decryption-capable destination domain 120 are shown communicatively coupled over a transmission system 130. Source domain 110 and destination domain 120 each include one or more electronic devices, such as personal computers, workstations, servers, printers, switches, routers, and the like (not shown). Where there is more than one electronic device in one of domains 110, 120, the multiple devices may be interconnected by electronic and/or optical links (not shown). Transmission system 130 includes zero or more intermediate optical devices 136, such as optical amplifiers and CDCs, serially coupled between source domain 110 and destination domain 120 via terminal optical links 132, 134 and transit optical links 138. It will be appreciated that where there are no intermediate optical devices, there are no transit links. In that event, a single optical link will interconnect source domain 110 and destination domain 120.

At the edge of source domain 110 are an electrical-optical converter (EOC) 112 and a CDE 114. EOC 112 converts unencrypted data signals received from one or more devices in source domain 110 and destined for one or more devices in destination domain 120 from electrical to optical form and passes the unencrypted signals to CDE 114 on optical link 116. CDE 114 is an optical assembly that induces a chromatic dispersion on the unencrypted signals to produce corresponding encrypted signals, which CDE 114 transmits on terminal link 132.

Transmission system 130 relays the encrypted signals from terminal link 132 to terminal link 134 via zero or more optical devices 136 and transit links 138.

At the edge of destination domain 120 are CDD 124 and optical-electrical converter (OEC) 122. Terminal link 134 passes the encrypted signals to CDD 124. CDD 124 is an optical assembly that induces a chromatic dispersion on the encrypted signals which is substantially equal and opposite to the chromatic dispersion induced by CDE 114 to substantially reproduce the corresponding unencrypted signals. CDD 124 passes the unencrypted signals to OEC 122 on optical data link 126. OEC 122 then passes the unencrypted signals to or toward the one or more devices in destination domain 120 for which the data are intended.

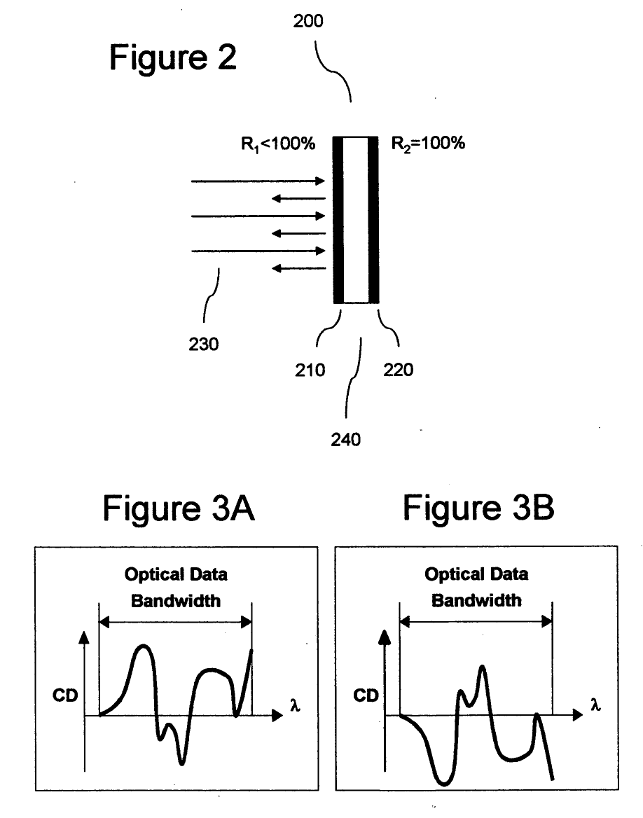

Turning to FIG. 2, a GTE 200 operative within CDE 114 for CD-encrypting data, and operative within CDD 124 for CD-decrypting data, is shown. GTE 200 has a first mirror 210 which has a reflectivity R₁ which is less than 100% and a second mirror 220 which has a reflectivity R₂ which is 100%. Light pulses 230 within one or more optical data bandwidths, such as International Telecommunications Union (ITU) transmission channels, enter and exit GTE 200 through first mirror 210. GTE 200 subjects different wavelength components of pulses 230 to variable delay due to its resonant properties. That is, the partial reflectivity of first mirror 210 causes certain wavelength components to be restrained in the glass cavity 240 between first mirror 210 and second mirror 220 longer than others. GTE 200 thereby imposes a wavelength-dependent time delay on the wavelength components of pulses 230 which induces a wavelength-dependent chromatic dispersion on pulses 230. GTE 200 can be configured to induce chromatic dispersion in accordance with any of various desired chromatic dispersion profiles through judicious selection of the length and refractive index of cavity 240, for example.

An exemplary arrangement for housing GTE 200 in an optical assembly such as CDE 114 and CDD 124 is described and shown in U.S. application Ser. No. 10/741,052 entitled “OPTICAL ASSEMBLY AND METHOD FOR FABRICATION THEREOF,” filed on Dec. 19, 2003, the contents of which are incorporated herein by reference.

Naturally, GTE 200 is just one type of optical device that may be used within CDE 114 and CDD 124 to induce chromatic dispersion. Other optical devices, such as ring resonators, may be used. Moreover, where CDE 114 and CDD 124 are GTE-based, CDE 114 and CDD 124 may each employ multiple GTEs serially connected on an optical path, and the optical path may be arranged so that light is redirected to each of the one or more GTEs more than once.

It bears noting that use of GTEs in the present application is different from conventional uses of GTEs in long-haul optical transmission systems. GTEs are often deployed long-haul optical transmission systems, such as Dense Wave Division Multiplexing (DWDM) systems, to reverse, or negate, unwanted chromatic dispersion accumulated on data during transmission. Here, GTEs are used to purposely induce chromatic dispersion on data that is substantially free of chromatic dispersion in order to encrypt it prior to transmission on an optical transmission system, and then to reverse, or negate, the purposely induced chromatic dispersion in order to decrypt it after transmission on the optical transmission system. The chromatic dispersion of interest in the present invention is not the unwanted chromatic dispersion that is the natural by-product of transmission of data on optical links.

Turning to FIG. 3A, an exemplary CD profile configured on CDE 114 for CD-encrypting data is shown. Unencrypted data signals are received from EOC 112 within an optical data bandwidth which corresponds, for example, to an ITU channel. As can be seen, the optical data bandwidth actually contains a narrow spectrum of wavelengths rather than a single wavelength. CDE 114 induces a near zero CD on signals received at the lower end of the spectrum, a CD that oscillates from positive to negative to positive and then back to near zero on signals received in the middle of the spectrum, and a positive CD on signals received at the upper end of the spectrum. This wavelength-dependent CD converts received signals that are sharp and readable by conventional means into signals that are distorted and unreadable by conventional means. Indeed, the sharp and readable signals are only reproducible through inducement of an equal and opposite chromatic dispersion on the optical data bandwidth.

Turning to FIG. 3B, an exemplary CD profile configured on CDD 124 for CD-decrypting data is shown. The CD profile is deliberately selected to negate the CD encryption induced by CDE 114. Encrypted data signals are received from transmission system 130 within the optical data bandwidth (e.g. an ITU channel). CDD 124 induces a substantially equal and opposite chromatic dispersion on the signals to that induced by CDE 114. Particularly, CDD 124 induces a near zero CD on signals received at the lower end of the spectrum, a CD that oscillates from negative to positive to negative and then back to near zero on signals received in the middle of the spectrum, and a negative CD on signals received at the upper end of the spectrum. The wavelength-dependent CD thereby converts received signals that are distorted and unreadable by conventional means into signals that are once again sharp and readable by conventional means.

Returning to FIG. 1 momentarily, it will be noted that the encrypted data signals transmitted on transmission system 130 will typically experience additional chromatic dispersion and optical loss during transmission over links 132, 134, 138. Such additional chromatic dispersion and optical loss may be compensated for by intermediate optical devices 136, particularly CDCs and optical amplifiers, so that the encrypted data signals that left source domain 110 are essentially reproduced upon arrival at destination domain 120. Through the judicious selection and deployment of intermediate optical devices 136, then, transmission system 130 can be made chromatically transparent to source domain 110 and destination domain 120.

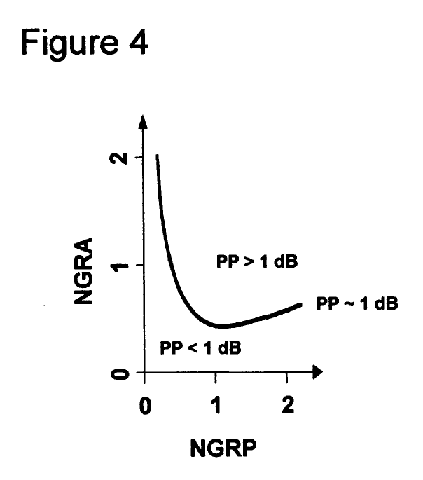

Turning to FIG. 4, combinations of normalized group ripple amplitude (NGRA) and normalized group ripple period (NGRP) which achieve a 1 dB power penalty for an NRZ modulation format are shown. A higher power penalty is associated with greater CD and therefore stronger CD encryption. NGRA is the ratio of the ripple amplitude of CD profile to the bit period of the data. NGRP is the ratio of the ripple period of the CD profile to the bit rate of the data. CD encryption strength may accordingly be controlled by selecting a ripple amplitude and ripple period combination for the CD profile configured on CDE 114 that is subject to a particular power penalty at the operative bit rate and bit period. For example, in a 10 Gbps transmission system wherein the bit rate is 80 picometers (pm) and the bit period is 100 picoseconds (ps), a CD profile with a ripple period on the order of 80 pm (i.e. NGRP=1) and a ripple amplitude on the order of 50 ps (i.e. NGRA=0.5) could be configured to achieve a power penalty on the order of 1 dB. Selection of a CD profile with a larger ripple amplitude would realize an even higher power penalty, that is, even less discernable and more secure data.

It will be appreciated by those of ordinary skill in the art that the invention can be embodied in other specific forms without departing from the spirit or essential character hereof. The present description is therefore considered in all respects illustrative and not restrictive. The scope of the invention is indicated by the appended claims, and all changes that come within the meaning and range of equivalents thereof are intended to be embraced therein.

I claim:

1. A data encryption system, comprising:
a source having a chromatic dispersion encrypter;
a destination having a chromatic dispersion decrypter; and
a transmission system operatively coupling the source and the destination.

2. The system of claim 1, wherein the chromatic dispersion encrypter induces a first chromatic dispersion on data prior to transmission of the data on the transmission system.

3. The system of claim 2, wherein the chromatic dispersion decrypter induces a second chromatic dispersion on the data after transmission of the data on the transmission system.

4. The system of claim 3, wherein the second chromatic dispersion substantially negates the first chromatic dispersion.

5. The system of claim 3, wherein the first chromatic dispersion and the second chromatic dispersion are substantially equal and opposite.

6. The system of claim 1, wherein the chromatic dispersion encrypter and the chromatic dispersion decrypter are etalon-based.

7. A data encryption method, comprising:
encrypting data using a first chromatic dispersion;
transmitting the data; and
decrypting the transmitted data using a second chromatic dispersion.

8. The method of claim 7, wherein the second chromatic dispersion substantially negates the first chromatic dispersion.

9. The method of claim 7, wherein the first chromatic dispersion and the second chromatic dispersion are substantially equal and opposite.

10. A data encryption method, comprising:
at a source, inducing upon data a first chromatic dispersion;
transmitting the data from the source to a destination; and
at the destination, inducing upon the data a second chromatic dispersion, wherein the second chromatic dispersion substantially negates the first chromatic dispersion.

11. The method of claim 10, wherein the first chromatic dispersion encrypts the data.

12. The method of claim 10, wherein the second chromatic dispersion decrypts the data.

13. The method of claim 10, wherein the first inducing step is performed using an etalon.

14. The method of claim 10, wherein the second inducing step is performed using an etalon.

15. A data encryption method, comprising:
inducing upon data a first chromatic dispersion without transmitting the data on an optical link;
transmitting the data with the first chromatic dispersion on an optical link;
inducing upon the data with the first chromatic dispersion a second chromatic dispersion, the second chromatic dispersion substantially negating the first chromatic dispersion.

16. The method of claim 15, wherein the first chromatic dispersion encrypts the data.

17. The method of claim 15, wherein the second chromatic dispersion decrypts the data.

18. The method of claim 15, wherein the first inducing step is performed using an etalon.

19. The method of claim 15, wherein the second inducing step is performed using an etalon.

20. A data encryption method, comprising:
receiving data;
encrypting the data using a first chromatic dispersion;
transmitting the encrypted data.

21. The method of claim 20, wherein the step of encrypting the data comprises inducing upon the data the first chromatic dispersion.

22. The method of claim 20, wherein the step of encrypting the data is performed using an etalon.

23. The method of claim 20, wherein the step of encrypting the data is performed without transmitting the data on an optical link.

24. The method of claim 20, further comprising receiving the encrypted data; and decrypting the encrypted data using a second chromatic dispersion.

25. The method of claim 24, wherein the step of decrypting the data comprises inducing upon the data the first chromatic dispersion.

26. The method of claim 24, wherein the step of decrypting the data is performed using an etalon.
